(19) United States
(12) Patent Application Publication
(10) Pub. No.: US 2025/0092930 A1
(43) Pub. Date: Mar. 20, 2025

(54) BRAKE SLACK ADJUSTMENT DEVICE

(71) Applicant: Emmanuel Gomez, Neptune, NJ (US)

(72) Inventor: Emmanuel Gomez, Neptune, NJ (US)

(21) Appl. No.: 18/370,095

(22) Filed: Sep. 19, 2023

(51) Int. Cl. F16D 65/46

(52) U.S. Cl. CPC F16D 65/46

(57) ABSTRACT

A brake slack adjustment device for adjusting the amount of slack in a pair of brake shoes includes a sleeve having a neck and a body extending from the neck. A threaded shaft rotatably engages the neck such that rotation of the threaded shaft extends and retracts the threaded shaft from the neck. A worm gear engages the threaded shaft. The threaded shaft is rotated by rotation of the worm gear. A head having a slot is coupled to the worm gear. The slot can engage a screwdriver to rotate the worm gear. A first slotted head is affixed to the body and is configured for engagement by a first brake shoe. A second slotted head is rotatably coupled to the threaded shaft. The second slotted head remains in an engagement orientation thereby engaging a second brake shoe while the threaded shaft rotates to extend or retract from the neck.

### CROSS-REFERENCE TO RELATED APPLICATIONS Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to brake pad adjustment devices and more particularly pertains to a new brake pad adjustment device for adjusting the length of a spacer to adjust the amount of slack in the brake shoes of a drum brake.

### (2) Description of Related Art Including Information Disclosed Under 37 CFR 1.97 and 1.98

The prior art relates to brake pad adjustment devices. Typically, brake pads are a part of a vehicle drum brake on the wheel of a car. Occasionally, the drum brakes need to be manually tightened or loosened to ensure the brakes are operating properly. In other words, the drum shoes need to have the proper amount of slack against the drum brake to slow and stop the vehicle as designed. Most drum brakes have a sprocket mechanism that needs to be rotated to adjust the slack. This adjuster is typically positioned between the two drum shoes. In most vehicles, the adjuster can be adjusted by manipulating a small gear or star wheel that is positioned on the adjuster. This star wheel can be very difficult to reach. Such star wheels are also typically designed to rotate in only one direction, or to be difficult to rotate in both directions. Thus, if the star wheel is rotated too far in one direction, it can overtighten the brakes, which can be extremely difficult to reverse. These star wheels, and the other gears used in the typical sprocket mechanism, are also prone to locking, stripping, or breakage. Thus, there is a need for a durable, easy to use design that provides improved adjustment of brake pads while eliminating the struggle associated with turning the typical sprocket-style mechanism.

### BRIEF SUMMARY OF THE INVENTION

An embodiment of the disclosure meets the needs presented above by generally comprising a sleeve having a neck and a body extending from the neck. A threaded shaft rotatably engages the neck such that rotation of the threaded shaft extends and retracts the threaded shaft out of and into the neck. In embodiments, the threaded shaft may extend through the body. A worm gear engages the threaded shaft wherein the threaded shaft is rotated by rotation of the worm gear. A head is coupled to the worm gear. The head has a slot therein that is configured for engagement by a screwdriver wherein the worm gear is configured to be rotated by the screwdriver when the screwdriver engages the slot. A first slotted head is affixed to the body and is configured for engagement by a first brake shoe. A second slotted head is rotatably coupled to the threaded shaft. The second slotted head remains in an engagement orientation while the threaded shaft rotates to extend or retract from the neck. The engagement orientation is configured for the second slotted shaft to be engaged by a second brake shoe. Extension or retraction of the threaded shaft thereby adjusts the slack of the first and second brake shoes within the vehicle drum brake.

There has thus been outlined, rather broadly, the more important features of the disclosure in order that the detailed description thereof that follows may be better understood, and in order that the present contribution to the art may be better appreciated. There are additional features of the disclosure that will be described hereinafter, and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a brake slack adjustment device according to an embodiment of the disclosure.

FIG. 2 is a side view of an embodiment of the disclosure.

FIG. 3 is a top view of an embodiment of the disclosure.

FIG. 4 is a back view of an embodiment of the disclosure.

FIG. 5 is a front view of an embodiment of the disclosure.

FIG. 6 is an in-use view of an embodiment of the disclosure.

FIG. 7 is a cross-sectional view of an embodiment of the disclosure.

### DETAILED DESCRIPTION OF THE INVENTION

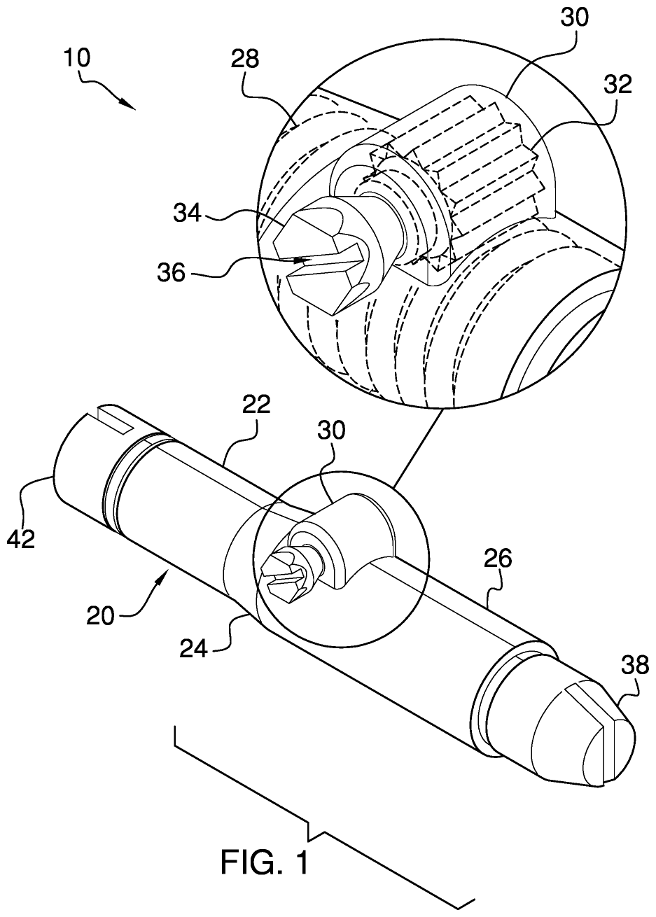

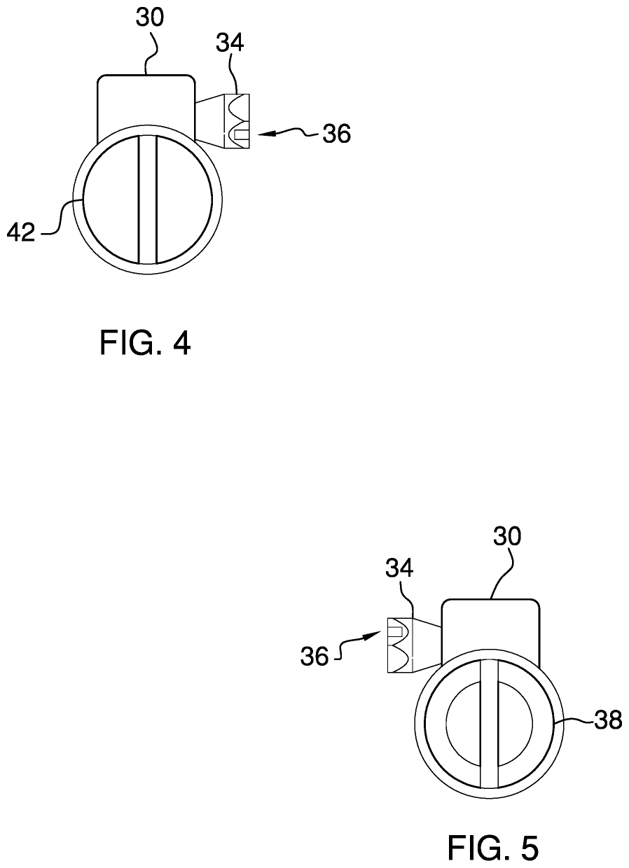

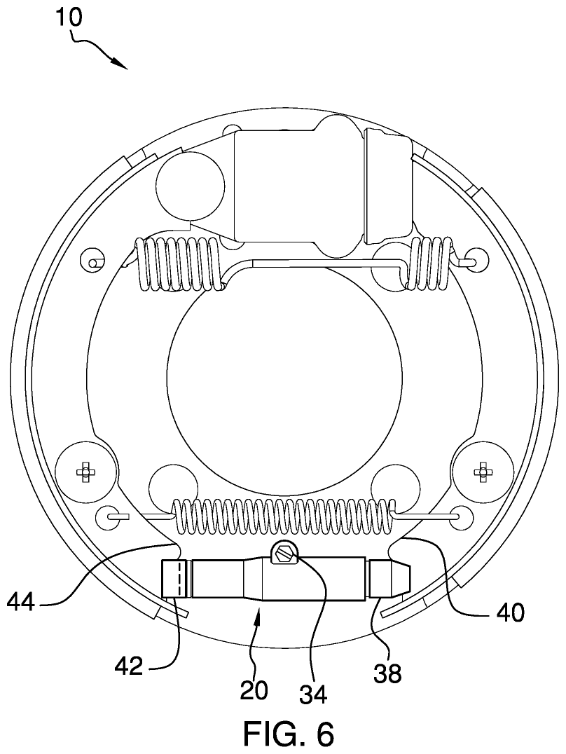

With reference now to the drawings, and in particular to FIGS. 1 through 7 thereof, a new brake pad adjustment device embodying the principles and concepts of an embodiment of the disclosure and generally designated by the reference numeral 10 will be described.

As best illustrated in FIGS. 1 through 7, the brake slack adjustment device 10 generally comprises a sleeve 20 having a neck 22 and a body 26 extending from the neck 22. In some embodiments, the sleeve 20 has a shoulder 24 extending between the neck 22 and the body 26.

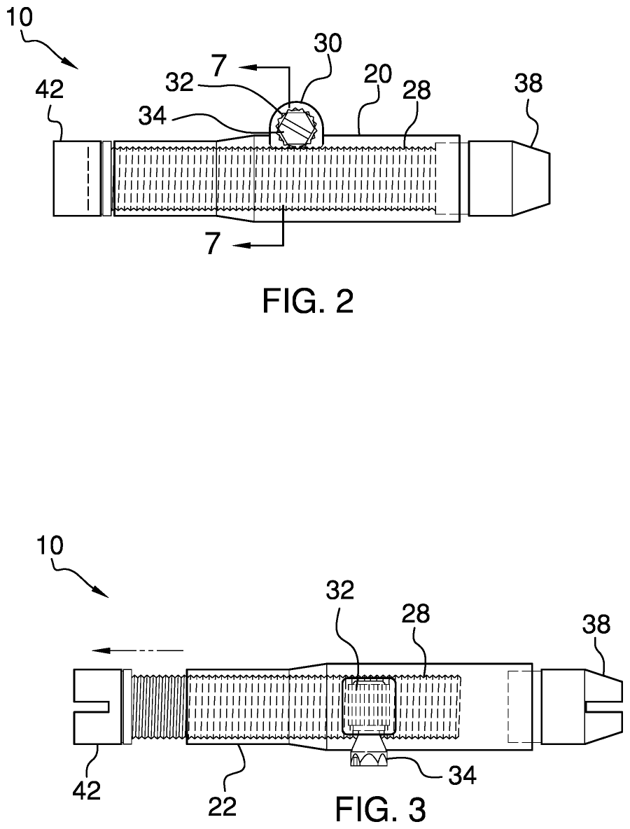

A threaded shaft 28 rotatably engages the neck 22 such that rotation of the threaded shaft 28 extends and retracts the threaded shaft 28 out of and into the neck 22. In some embodiments, the threaded shaft 28 extends through the body 26 within the sleeve 20, as shown in FIGS. 2 and 3.

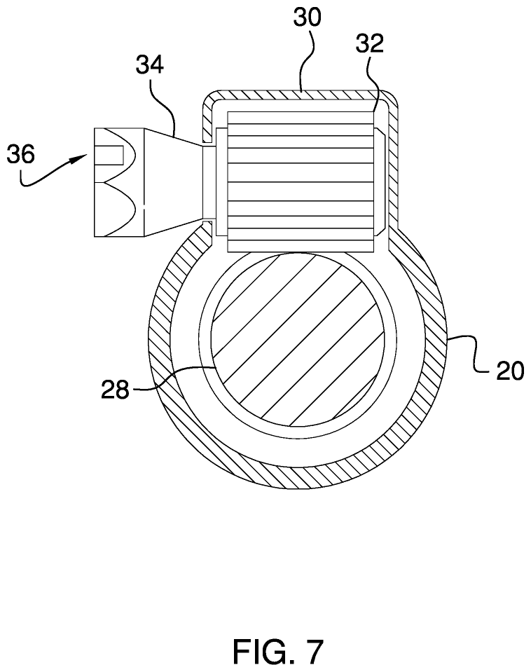

A housing 30 may be coupled to the sleeve 20. For example, the housing 30 may be positioned on the body 26 proximate to the shoulder 24, as shown in FIG. 1. A worm gear 32 is rotatably coupled to the housing 30 and engages the threaded shaft 28 wherein the threaded shaft 28 is rotated by rotation of the worm gear 32. In such embodiments, the housing 30 may be integrally coupled to the sleeve 20, or the housing 30 and sleeve 20 may otherwise form a single manufactured piece, as shown in FIG. 7. In other embodiments, the housing 30 may be absent such that the worm gear 32 itself is positioned on the sleeve to rotatably engage the threaded shaft 28.

A head 34 extends outwardly from the housing 20 or the worm gear 32. The head 34 is coupled to the worm gear 32. The head 34 has a slot 36 therein that is configured for engagement by a screwdriver wherein the worm gear 32 is configured to be rotated by the screwdriver when the slot 36 engages the screwdriver. For example, a first direction of rotation of the worm gear 32 may extend the threaded shaft 28 outwardly from the sleeve 20 and a second direction of rotation of the worm gear 32 may retract the threaded shaft 28 inwardly toward the sleeve 20. In some embodiments, the first direction is clockwise, and the second direction is counterclockwise. In other embodiments, the first direction may be counterclockwise, and the second direction may be clockwise.

The brake slack adjustment device 10 further comprises a first slotted head 38 that is to the body 26. The first slotted head 38 is configured for engagement by a first brake shoe 40. The brake slack adjustment device also comprises a second slotted head 42 that is rotatably coupled to the threaded shaft 28. The second slotted head 42 remains in an engagement orientation while the threaded shaft 28 rotates to extend or retract. The engagement orientation comprises a position wherein the second slotted head 42 is configured for engagement by a second brake shoe 44. When the first slotted head 38 engages the first brake shoe 40 and the second slotted head 42 engages the second brake shoe 44, extension or retraction of the threaded shaft 28 adjusts a position of the first brake shoe 40 relative to the second brake shoe 44. The brake slack adjustment device 10 is thereby able to tighten or loosen the first 40 and second 44 brake shoes to adjust the brakes within the brake drum.

In use, a user can engage the slot 36 on the head 34 with a screwdriver. The user can rotate the screwdriver to rotate the worm gear 32 thereby rotating the threaded shaft 28 and extending or retracting the threaded shaft 28 relative to the sleeve 20. As indicated above, extending the threaded shaft 28 outwardly from the sleeve 20 can push the first 40 and second 44 brake shoes further apart from one another to tighten the brakes. Retracting the threaded shaft 28 inwardly toward the sleeve 20 can pull the first 40 and second 44 brakes shoes closer together to loosen the brakes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A slack adjuster for a vehicle drum brake, the slack adjuster comprising:
a sleeve having a neck, a shoulder, and a body extending from the neck, the shoulder extending between the neck and the body;
a threaded shaft rotatably engaging the neck such that rotation of the threaded shaft extends and retracts the threaded shaft out of and into the neck;
a worm gear engaging the threaded shaft wherein the threaded shaft is rotated by rotation of the worm gear;
a head being coupled to the worm gear, the head having a slot therein, the slot being configured for engagement by a screwdriver wherein the worm gear is configured to be rotated by the screwdriver;
a first slotted head being affixed to the body, the first slotted head being configured for engagement by a first brake shoe;
a second slotted head being rotatably coupled to the threaded shaft, wherein the second slotted head remains in an engagement orientation while the threaded shaft rotates to extend or retract, the engagement orientation being configured for the second slotted head to be engaged by a second brake shoe.

2. The slack adjuster of claim 1, further comprising a housing being coupled to the sleeve, wherein the worm gear is rotatably coupled to the housing and wherein the head extends outwardly from the housing.

3. The slack adjuster of claim 2, the sleeve further comprising a shoulder extending between the neck and the body, wherein the housing is attached to the body proximate to the neck

4. The slack adjuster of claim 1, wherein a first direction of rotation of the worm gear extends the threaded shaft outwardly from the sleeve.

5. The slack adjuster of claim 4, wherein the first direction is clockwise.

6. The slack adjuster of claim 4, wherein the first direction is counterclockwise.

7. The slack adjuster of claim 1, wherein a second direction of rotation of the worm gear retracts the threaded shaft inwardly toward the sleeve.

8. The slack adjuster of claim 7, wherein the second direction is counterclockwise.

9. The slack adjuster of claim 7, wherein the second direction is clockwise.

10. The slack adjuster of claim 1, wherein the threaded shaft extends through the body.

11. A slack adjuster for a vehicle drum brake, the slack adjuster comprising:
a sleeve having a neck, a shoulder, and a body extending from the neck, the shoulder extending between the neck and the body;
a threaded shaft rotatably engaging the neck such that rotation of the threaded shaft extends and retracts the threaded shaft out of and into the neck, the threaded shaft extending through the body;
a housing being coupled to the sleeve proximate to the shoulder;
a worm gear being rotatably coupled to the housing and engaging the threaded shaft wherein the threaded shaft is rotated by rotation of the worm gear;
a head extending outwardly from the housing, the head being coupled to the worm gear, the head having a slot therein, the slot being configured for engagement by a screwdriver wherein the worm gear is configured to be rotated by the screwdriver when the slot engages the screwdriver;
a first direction of rotation of the worm gear extending the threaded shaft outwardly from the sleeve, the first direction being clockwise;
a second direction of rotation of the worm gear retracting the threaded shaft inwardly toward the sleeve, the second direction being counterclockwise;
a first slotted head being affixed to the body, the first slotted head being configured for engagement by a first brake shoe; and
a second slotted head being rotatably coupled to the threaded shaft, wherein the second slotted head remains in an engagement orientation while the threaded shaft rotates to extend or retract, the engagement orientation being configured for the second slotted head to be engaged by a second brake shoe, whereby extension or retraction of the threaded shaft from the neck adjusts a position of the first brake shoe relative to the second brake shoe.
